(19) United States
(12) Patent Application Publication
(10) Pub. No.: US 2007/0186165 A1
(43) Pub. Date: Aug. 9, 2007

(54) Method And Apparatus For Electronically Providing Advertisements

(75) Inventors: Ariel Maislos, Sunnyvale, CA (US); Ruben Maislos, Or-Yehuda (IL); Eran Arbel, Cupertino, CA (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: PUDDING LTD., Kefar-Saba (IL)

(21) Appl. No.: 11/672,062

(22) Filed: Feb. 7, 2007

Related U.S. Application Data
(60) Provisional application No. 60/765,743, filed on Feb. 7, 2006.

(51) Int. Cl. G06F 3/16; G06F 3/00

(52) U.S. Cl. 715/728; 715/727; 715/733

(57) ABSTRACT

Methods, apparatus and computer-code for electronically providing advertisement are disclosed herein. In some embodiments, advertisements are provided in accordance with at least one feature of electronic media content of a multi-party conversation, for example, by targeting at least one advertisement to at least one individual associated with a party of the multi-party voice conversation. Optionally, the multi-party conversation is a video conversation and at least one feature is a video content feature. Exemplary features include but are not limited to speech delivery features, key word features, topic features, background sound or image features, deviation features and biometric features. Techniques for providing advertisements in accordance with any voice electronic media content, including but not limited to voice mail content, are also disclosed.

### CROSS-REFERENCE TO RELATED APPLICATIONS

This patent application claims the benefit of U.S. Provisional Patent Application No. 60/765,743 filed Feb. 7, 2006 by the present inventors.

### FIELD OF THE INVENTION

The present invention relates to techniques for facilitating advertising in accordance with electronic media content, such as electronic media content of a multi-party conversation.

### BACKGROUND AND RELATED ART

With the growing number of Internet users, advertisements using the Internet (Internet advertisements) are becoming increasingly popular. To date, various on-line service providers (for example, content providers and search engines) serve internet advertisements to users (for example, to a web browser residing on a user's client device) who receive the advertisement when accessing the provided services.

One effect of Internet-based advertisement is that it provides revenue for providers of various Internet-based services, allowing the service-provider to obtain revenue and ultimately lowering the price of Internet-based services for users. It is known that many purchasers of advertisements wish to ‘target’ their advertisements to specific groups that may be more receptive to certain advertisements.

Thus, targeted advertisement provides opportunities for all—for users who receive more relevant advertisements and are not ‘distracted’60 by marginally-relevant advertisements and who also are able to benefit from at least partially advertisement-supported service; for service providers who have the opportunity to provide advertisement-supported advertisements; and for advertisers who may more effectively use their advertisement budget.

Because targeted advertisement can provide many benefits, there is an ongoing need for apparatus, methods and computer code which provide improved targeted advertisements.

The following published patent applications provide potentially relevant background material: US 2006/0167747; US 2003/0195801; US 2006/0188855; US 2002/0062481; and US 2005/0234779.

All references cited herein are incorporated by reference in their entirety. Citation of a reference does not constitute an admission that the reference is prior art.

### SUMMARY

According to some embodiments of the present invention, a method for facilitating the provisioning of advertisement is provided. This method comprises: a) providing electronic media content (e.g. digital audio content and optionally digital video content) of a multi-party voice conversation (i.e. voice and optionally also video); b) in accordance with at least one feature of the electronic media content, providing at least one advertisement to at least one individual associated with a party of the multi-party voice conversation.

A Discussion of Various Features of Electronic Media Content

According to some embodiments, the at least one feature of the electronic media content includes at least one speech delivery feature—i.e. describing how a given set of words is delivered by a given speaker.

Exemplary speech delivery features include but are not limited to: accent features (i.e. which may be indicative, for example, of whether or not a person is a native speaker and/or an ethnic origin), speech tempo features, voice pitch features (i.e. which may be indicative, for example, of an age of a speaker), voice loudness features, voice inflection features (i.e. which may indicative of a mood including but not limited to angry, confused, excited, joking, sad, sarcastic, serious, etc) and an emotional outburst feature (defined here as a presence of laughing and/or crying).

In some embodiments, the multi-party conversation is a video conversation, and the at least one feature of the electronic media content includes a video content feature.

Exemplary video content features include but are not limited to:

i) visible physical characteristic of a person in an image—including but not limited to indications of a size of a person and/or a person's weight and/or a person's height and/or eye color and/or hair color and/or complexion;

ii) feature of objects or person's in the ‘background’—i.e. background object other than a given speaker—for example, including but not limited to room furnishing features and a number of people in the room simultaneously with the speaker;

iii) a detected physical movement feature—for example, a body-movement feature including but not limited to a feature indicative of hand gestures or other gestures associated with speaking.

According to some embodiments, the at least one feature of the electronic media content includes at least one key words features indicative of a presence and/or absence of key words or key phases in the spoken content and the advertisement targeting is carried out in accordance with the at least one key word feature.

In one example, the key words feature is determined by using a speech-to-text converter for extracting text. The extracted text is then analyzed for the presence of key words or phrases. Alternatively or additionally, the electronic media content may be compared with sound clips that include the key words or phrases.

According to some embodiments, the at least one feature of the electronic media content includes at least one topic category feature—for example, a feature indicative if a topic of a conversation or portion thereof matches one or more topic categories selected from a plurality of topic categories—for example, including but not limited to sports (i.e. a conversation related to sports), romance (i.e. a romantic conversation), business (i.e. a business conversation), current events, etc.

According to some embodiments, the at least one feature of the electronic media content includes at least one topic change feature. Exemplary topic change features include but are not limited to a topic change frequency, an impending topic change likelihood, an estimated time until a next topic change, and a time since a previous topic change.

Thus in one example, it may be considered advantageous to serve ads more frequently when the rate of topic change higher. In another example, it may be considered advantageous to attempt to time the provisioning of some types of advertisements at a time of topic change, and other types of advertisements at other times.

In some embodiments, the at least one feature of the electronic media content includes at least one feature ‘demographic property’ indicative of and/or derived from at least one demographic property or estimated demographic property (for example, age, gender, etc) of a person involved in the multi-party conversation (for example, a speaker).

Exemplary demographic property features include but are not limited to gender features (for example, related to voice pitch or from hair length or any other gender features), educational level features (for example, related to spoken vocabulary words used), household income feature (for example, related to educational level features and/or key words related to expenditures and/or images of room furnishings), a weight feature (for example, related to overweight/underweight—e.g. related to size in an image or breathing rate where obese individuals or more likely to breath at a faster rate), age features (for example, related to an image of a balding head or gray hair and/or vocabulary choice and/or voice pitch), ethnicity (for example, related to skin color and/or accent and/or vocabulary choice). Another feature that, in some embodiments, may indicate a person's demography is the use (or lack of usage) of certain expressions, including but not limited to profanity. For example, people from certain regions or age groups may be more likely to use profanity (or a certain type), while those from other regions or age groups may be less likely to use profanity (or a certain type).

Not wishing to be bound by theory, it is noted that there are some situations where it is possible to perform ‘on the fly demographic profiling’ (i.e. obtaining demographic features derived from the media content) obviating the need, for example, for ‘explicitly provided’ demographic data—for example, from questionnaires or purchased demographic data. This may allow, for example, targeting of more appropriate or more effective advertisements.

Demographic property features may be derived from audio and/or video features and/or word content features. Exemplary features from which demographic property features may be derived from include but are not limited to: idiom features (for example, certain ethnic groups or people from certain regions of the United States may tend to use certain idioms), accent features, grammar compliance features (for example, more highly educated people are less likely to make grammatical errors), and sentence length features (for example, more highly educated people are more likely to use longer or more ‘complicated features’).

In one example, people associated with the more highly educated demographic group are more likely to receive ads from certain book vendors, or are more likely to receive a coupon for a discount to the opera. Persons (for example, those who speak during the conversation) from the teenage demographic are more likely to receive ads for certain music products, and the like.

In some embodiments, the at least one feature of the electronic media content includes at least one ‘physiological feature’ indicative of and/or derived from at least one physiological property or estimated demographic property (for example, age, gender, etc) of a person involved in the multi-party conversation (for example, a speaker)—i.e. as derived from the electronic media content of the multi-party conversation.

Exemplary physiological parameters include but are not limited to breathing parameters (for example, breathing rate or changes in breathing rate), a sweat parameters (for example, indicative if a subject is sweating or how much—this may be determined, for example, by analyzing a ‘shininess’ of a subject's skin, a coughing parameter (i.e. a presence or absence of coughing, a loudness or rate of coughing, a regular or irregularity of patterns of coughing), a voice-hoarseness parameter, and a body-twitching parameter (for example, twitching of the entire body due to, for example, chills, or twitching of a given body part—for example, twitching of an eyebrow).

In one example, the body-twitching parameter may be indicative of whether or not a given person is healthy or sick. In another example, a person may twitch a body part when nervous or lying.

In some embodiments, the at least one feature of the electronic media content includes at least one feature ‘background item feature’ indicative of and/or derived from background sounds and/or a background image. It is noted that the background sounds may be transmitted along with the voice of the conversation, and thus may be included within the electronic media content of the conversation.

In one example, if a dog is barking in the background and this is detected, an advertisement for a pet item may be provided.

The background sound may be determined or identified, for example, by comparing the electronic media content of the conversation with one or more sound clips that include the sound it is desired to detect. These sound clips may thus serve as a ‘template.’

In another example, if a certain furniture item (for example, an ‘expensive’ furniture item) is detected in the background of a video conversation, an item (i.e. good or service) appropriate for the ‘upscale’ income group may be provided.

In yet another example, if an image of a crucifix is detected in the background of a video conversation, an advertisement for a Christian-oriented product or service may be provided.

In some embodiments, the at least one feature of the electronic media content includes at least one feature temporal and/or spatial localization feature indicative of and/or derived from a specific location or time. Thus, in one example, if a speaker is in a certain geographical location advertisements for that location (for example, retail establishments in that location) are provided. In another example, around mealtimes, advertisements for various meals may be provided.

This localization feature may be determined from the electronic media of the multi-party conversation.

Alternatively or additionally, this localization feature may be determined from data from an external source—for example, a GPS and/or mobile phone triangulation.

Another example of an ‘external source’ for localization information is a dialed telephone number. For example, certain area codes or exchanges may be associated (but not always) with certain physical locations.

In some embodiments, the at least one feature of the electronic media content includes at least one ‘historical feature’ indicative of electronic media content of a previous multi-party conversation and/or an earlier time period in the conversation—for example, electronic media content who age is at least, for example, 5 minutes, or 30 minutes, or one hour, or 12 hours, or one day, or several times, or a week, or several weeks.

In some embodiments, the at least one feature of the electronic media content includes at least one ‘deviation feature.’ Exemplary deviation features of the electronic media content of the multi-party conversation include but are not limited to:

a) historical deviation features—i.e. a feature of a given subject or person that changes temporally so that a given time, the behavior of the feature differs from its previously-observed behavior. Thus, in one example, a certain subject or individual usually speaks slowly, and at a later time, this behavior ‘deviates’ when the subject or individual speaks quickly. In another example, a typically soft-spoken individual speaks with a louder voice. In another example, an individual who 3 months ago was observed (e.g. via electronic media content) to be of average or above-average weight is obese.

In another example, a person who is normally polite may become angry and rude—this may an example of ‘user behavior features.’

b) inter-subject deviation features—for example, a ‘well-educated’ person associated with a group of lesser educated persons (for example, speaking together in the same multi-party conversation), or a ‘loud-spoken’ person associated with a group of ‘soft-spoken’ persons, or ‘Southern-accented’ person associated with a group of persons with Boston accents, etc. If distinct conversations are recorded, then historical deviation features associated with a single conversation are referred to as intra-conversation deviation features, while historical deviation features associated with distinct conversations are referred to as inter-conversation deviation features.

c) voice-property deviation features—for example, an accent deviation feature, a voice pitch deviation feature, a voice loudness deviation feature, and/or a speech rate deviation feature. This may related to user-group deviation features as well as historical deviation features

d) physiological deviation features—for example, breathing rate deviation features, weight deviation features—this may related to user-group deviation features as well as historical deviation features.

e) vocabulary or word-choice deviation features—for example, profanity deviation features indicating use of profanity—this may related to user-group deviation features as well as historical deviation features.

f) person-versus-physical-location—for example, a person with a Southern accent whose location is determined to be in a Northern city (e.g. Boston) might be provided with a hotel coupon.

In some embodiments, the at least one feature of the electronic media content includes at least one ‘person-recognition feature.’ This may be useful, for example, for providing advertisement targeted for a specific person. Thus, in one example, the person-recognition feature allows access to a database of person-specific data where the person-recognition feature functions, at least in part, as a ‘key’ of the database. In one example, the ‘data’ may be previously-provided data about the person, for example, demographic data or other data, that is provided in any manner, for example, derived from electronic media of a previous conversation, or in any other manner. In some embodiments, this may obviate the need for users to explicitly provide account information and/or to log in order to receive ‘personalized’ advertising content. Thus, in one example, the user simply uses the service, and the user's voice is recognized from a voice-print. Once the system recognizes the specific user, it is possible to provision advertisement in accordance with previously-stored data describing preferences of the specific user.

Exemplary ‘person-recognition’ features include but are not limited to biometric features (for example, voice-print or facial features) or other person visual appearance features, for example, the presence or absence of a specific article of clothing.

It is noted that the possibility of recognizing a person via a ‘person-recognition’ feature does not rule out the possibility of using more ‘conventional’ techniques—for example, logins, passwords, PINs, etc.

In some embodiments, the at least one feature of the electronic media content includes at least one ‘handedness feature’ indicative of whether or not a person (for example, a speaking person in a video conversation) is left-handed or right handed. In one example, the person may be observed during the video conversation writing, for example, with his left hand. According to this example, ‘left-handed specific’ advertisement may be targeted to the person for which the electronic media content indicates, is left-handed. For example, the person identified as left-handed may receive an advertisement for a left-handed baseball glove or other sporting-goods item.

In some embodiments, the at least one feature of the electronic media content includes at least one ‘person-influence feature.’ Thus, it is recognized that during certain conversations, certain individuals may have more influence than others—for example, in a conversation between a boss and an employee, the boss may have more influence and may function as a so-called gatekeeper. In some embodiments, advertisements are targeted according to gatekeeper status or a person-influence features. This may be determined, for example, from vocabulary choices and/or demographic data and/or body language.

In some embodiments, the at least one feature of the electronic media content includes at least one ‘statement-influence feature.’ For example, if one party of the conversation makes a certain statement, and this statement appears to influence one or more other parties of the conversation, the ‘influencing statement’ may be assigned more importance. For example, if party ‘A’ says ‘we should spend more money on clothes' and party ‘B’ responds by saying ‘I agree’ this could imbue party A's statement with additional importance, because it was an ‘influential statement.’

In some embodiments, the targeting of advertising includes targeting advertisement to a first individual (for example, person ‘A’) in accordance with one or more feature of media content from a second individual different from the first individual (for example, person ‘B’).

### A Brief Discussion of Targeting of Advertising

There are many ways that the ‘targeting of advertisement’ may be carried out. In some embodiments, the frequency of serving of advertisements is determined at least in part by the electronic media content of the multi-party conversations. In one example, teenagers (i.e. as identified from the electronic media content).

may be served different ads at a rate that is more frequency than the rate used for elderly person (i.e. as identified from the electronic media content). Alternatively or additionally, the ‘residence time’ or amount of time an advertisement is displayed ion a screen may be determined in accordance with one or more features of the electronic media—for example, longer residence times for elderly individuals and shorter residence times for teenagers.

Alternatively or additionally, an advertisement(s) may be selected from a pre-determined pool of advertisements in accordance with the computed at least one feature. In one example, a car vendor provides 5 different advertisements, each advertisement being associated with a different model (sports car, mini-van, luxury card, economy car and SUV). According to this example, if the electronic media content is indicative of an individual who speaks ‘sports-oriented’ key words the advertisement for the SUV or sports-car may be selected. If the electronic media content is indicative of an individual between the ages of 30 and 55 with several children in the house-hold, the advertisement for the mini-van may be selected. If the electronic media content includes an individual associated with a ‘high household income’ demographic group, In another example, an advertisement is displayed using ‘large fonts’ or in a large size for elderly individuals.

In some embodiments, a pre-determined ad may be customized in accordance with one or more features of the electronic media content. For example, a person identified as a ‘high-income’ individual may receive an advertisement for a car with more add-on features, while a ‘middle-income’ individual may receive an advertisement for the same car, albeit with few add-on features.

The advertisement may be provided, for example, via email or via SMS or via web—browser or in an integrated with a client-chat application, or in any other manner. In one example, a mailing list (i.e. for snail-mail letters) may be electronically modified in accordance with one or more features of the electronic media content.

In another example, a pricing parameter (i.e. for example, a product or service price, or, for example, a discount size) may be determined in accordance with one or more features of the electronic media content. In one example, a middle-income person (i.e. as determined from one or more features of the electronic media content) maybe given a ‘bigger’ discount than an affluent individual, or vice-versa.

In another example, an offered-item (i.e. product or service) time-interval parameter of advertisement(s) may be determined in accordance with one or more features of the electronic media of the multi-party conversation. For example, a certain restaurant may offer a coupon valid between 5 PM and 7 PM for elderly individuals, and between 9 PM and 12 PM for young adults. In another example, a coupon may expire quickly for ‘middle class’ individuals in order to motivate them to make a quick purchase, and may have a later expiration data for possibly less price-sensitive affluent individuals (i.e. as identified from the electronic media content).

In some embodiments, the method may be ‘adaptive’—i.e. successive advertisements may be influenced by reactions to the earlier-provided advertisements. The reactions may be determined, for example, from the electronic media content, for example, from comments made about the advertisements, or eye contact with a certain location on the screen where an advertisement is being served, or from other reactions not necessarily associated with the electronic media content, for example, click through or coupon redemptions.

### Configuring a Client Device

It is now disclosed for the first time a method of facilitating advertising, the method comprising: a) receiving electronic media content of a multi-party voice conversation from at least one client device; and b) configuring at least one of the client devices to present advertisement in accordance with at least one feature of the electronic media content.

The configuring may be carried out, for example, by sending an email or by configuring a downloaded client, or in any other manner.

### Electronic Media Content Other than Content of a Multi-Party Conversation

Throughout this disclosure, various techniques and systems for facilitating advertisement in accordance with electronic media content of multi-party conversations are described.

It is now also disclosed that these techniques are not limited to the case of multi-party voice conversations.

In one example, a voice-mail service is provided where the voice messages of various callers are received and stored in volatile and/or non-volatile memory. According to this example, advertisement is provisioned, for example, to the recipient of the voice mail and/or the caller in accordance with one or more features of the electronic media content of the voice mail message.

In one example, monetary remuneration is provided to the owner of the voice mail box and/or a caller. Alternatively or additionally, this service, which is normally provided for a fee, is instead provided for a reduced fee or no fee in exchange with the right to provision advertisements in accordance with the stored voice mail messages.

In one example, the advertisement may be provided as a separate voice mail, or may be emailed to a targeted party. Alternatively or additionally, the advertisement may be displayed on the screen of a cellphone of the caller at the time the voice mail message is provided, or thereafter. In another example, the advertisements may include certain coupons or prizes, providing all added incentive to subscribe to this service.

Thus, it is now disclosed for the first time a method of facilitating advertising comprising: a) effecting at least one voice-content operation selected from the group consisting of: i) recording an audio voice signal to generate digital audio media content; ii) effecting a digital audio media content playback operation; b) computing a feature of the digital audio media content; and c) providing at least one advertisement in accordance with the at least feature.

Thus, in one example, the providing is in accordance with the recording of a message—this may include ‘recording’ content received over a telecommunications network by storing in volatile and/or non-volatile memory.

Alternatively, the providing is in accordance with the playing back of the voice content (for example, the voice mail message).

It is noted that the ‘voice mail’ example is intended as an example and not as a limitation. In another example, a user may record audio ‘notes’ and advertisement may be provided. In one example, a specific device for example a reduced-price dedicated device for recording is sold or distributed. This specific device is operative to present (i.e. display or playback audio) one or more advertisements in accordance with audio content handled by the dedicated device.

Apparatus for Providing Advertisement-Related Services

Some embodiments of the present invention provide apparatus for facilitating advertising. The apparatus may be operative to implement any method or any step of any method disclosed herein. The apparatus may be implemented using any combination of software aid/or hardware.

Thus, it is now disclosed for the first time an apparatus useful for facilitating advertising, the apparatus comprising: a) a data storage operative to store electronic media content of a multi-party voice conversation including spoken content of the conversation; and b) a data presentation interface (i.e. either textual or a graphic user interface) operative to present (i.e. with sound and/or display images) at least one advertisement in accordance with at least feature of the electronic media content.

The data storage may be implemented using any combination of volatile and/or non-volatile memory, and may reside in a single device or reside on a plurality devices either locally or over a wide area.

The aforementioned apparatus may be provided as a single client device (for example, as a handset or laptop or desktop configured to present advertisements in accordance with the electronic media content). In this example, the ‘data storage’ is volatile and/or non-volatile memory of the client device for example, where outgoing and incoming content is digitally stored in the client device or a peripheral storage device of the client device.

Alternatively or additionally, the apparatus may be distributed on a plurality of devices for example with a ‘client-server’ architecture.

In some embodiments, the apparatus further includes: c) a media input operative to receive at least one of audio and video input (for example, including a microphone and/or a camera operatively linked with an analog to digital converter or media encoder for example, implemented using any combination of hardware and software).

In some embodiments, the apparatus further includes: c) a feature calculation engine operative to calculate the at least one feature of the electronic media content.

As with any component disclosed herein, the feature calculation engine may be implemented using any combination of hardware and/or software. Furthermore, the feature engine may reside in the same device as the presentation interface and/or storage, or on a different device.

It is now disclosed for the first time an apparatus for facilitating advertising, the apparatus comprising: a) a data storage operative to store electronic media content of a multi-party voice conversation including spoken content of the conversation; and b) an advertisement serving engine operative to serve at least one advertisement in accordance with at least feature of the electronic media content.

In some embodiments, the feature calculation engine resides at least in part on at least one client terminal device of the multi-party voice conversation.

Alternatively, the feature calculation engine resides on a server or a device separate from the client terminal device (e.g. cellphone or desktop or PDA or laptop) used for client communication in the multi-party conversation.

### Additional Discussion of Methods for Facilitating Advertising

It is now disclosed for the first time a method of facilitating advertising, the method comprising: a) providing a telecommunications service where a plurality of users send electronic media content via a telecommunications channel; and b) providing an advertisement service where advertisement content is distributed to at least one target associated with at least one user in accordance with the electronic media content transmitted via the telecommunications service.

In some embodiments, communications service is a web-based telecommunications service, for example, provided using a browser client or a download’ client installed on a laptop or desktop machine. Thus, in some embodiments, the telecommunications channel may include VOIP features and transmitted over a packet-switched network.

Alternatively, the communications service may be a more ‘traditional’ circuit-switched network communications service.

Some embodiments of the present invention provide techniques useful for selling advertisement (or rights to advertise) for the aforementioned service. Thus, in one example, an advertisement is served to many users, but the price paid for the right to distribute the advertisement to a given user may depend on the voice content of the user's multi-party phone conversation.

In one example, if the electronic media content of the multi-party voice conversation is indicative that one or more user's belong to a ‘high income’ demographic group (or highly educated), the price paid for the right to serve the advertisement may be higher than the price paid for serving the same advertisement to a user whose voice multi-party conversation indicates membership of a less affluent demographic group.

Thus, it is now disclosed for the first time a method of facilitating advertising comprising: a) providing a telecommunications service where a plurality of users send electronic media content via a telecommunications channel; b) receiving advertisement input content for distribution; and c) effecting at least one advertisement handling operation in accordance with at least feature of transmitted electronic media content of the telecommunications service, where at least one advertisement handling operation is selected from the group consisting of: i) distributing advertisement content derived from the received advertisement input content (for example, to users of the telecommunications service); and ii) billing (for example, computing a price for the right to distribute a given advertisement or group of advertisements) for distribution of the advertisement input content in accordance with said electronic media sent via said telecommunications service.

These and further embodiments will be apparent from the detailed description and examples that follow.

### BRIEF DESCRIPTION OF THE DRAWINGS

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the invention is to cover all modifications, equivalents and alternatives falling within the spirit and scope of the present invention. As used throughout this application, the word “may” is used in a permissive sense (i.e., meaning “having the potential to’), rather than the mandatory sense (i.e. meaning “must”).

FIGS. 1A-1D describe exemplary use scenarios.

FIG. 2 provides a flow chart of an exemplary technique for facilitating advertising.

FIG. 3 describes an exemplary technique for computing one or more features of electronic media content including voice content.

FIG. 4-5 describes exemplary techniques for targeting advertisement.

FIG. 6 describes an exemplary adaptive technique for targeting advertisement.

FIG. 7 describes an exemplary system for providing a multi-party conversation.

FIGS. 8-14 describes exemplary systems for computing various features.

FIG. 15 describes an exemplary system for targeting advertisement

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for facilitating advertising is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

Embodiments of the present invention relate to a technique for provisioning advertisements in accordance with the context and/or content of voice content—including but not limited to voice content transmitted over a telecommunications network in the context of a multiparty conversation.

Certain examples of related to this technique are now explained in terms of exemplary use scenarios. After presentation of the use scenarios, various embodiments of the present invention will be described with reference to flow-charts and block diagrams. It is noted that the use scenarios relate to the specific case where the advertisements are presented ‘visually’ by the client device. In other examples, audio advertisements may be presented—for example, before, during or following a call or conversation.

Also, it is noted that the present use scenarios and many other examples relate to the case where the multi-party conversation is transmitted via a telecommunications network (e.g. circuit switched and/or packet switched). In other example, two or more people are conversing ‘in the same room’ and the conversation is recorded by a single microphones or plurality of microphones (and optionally one or more cameras) deployed ‘locally’ without any need for transmitting content of the conversation via a telecommunications network.

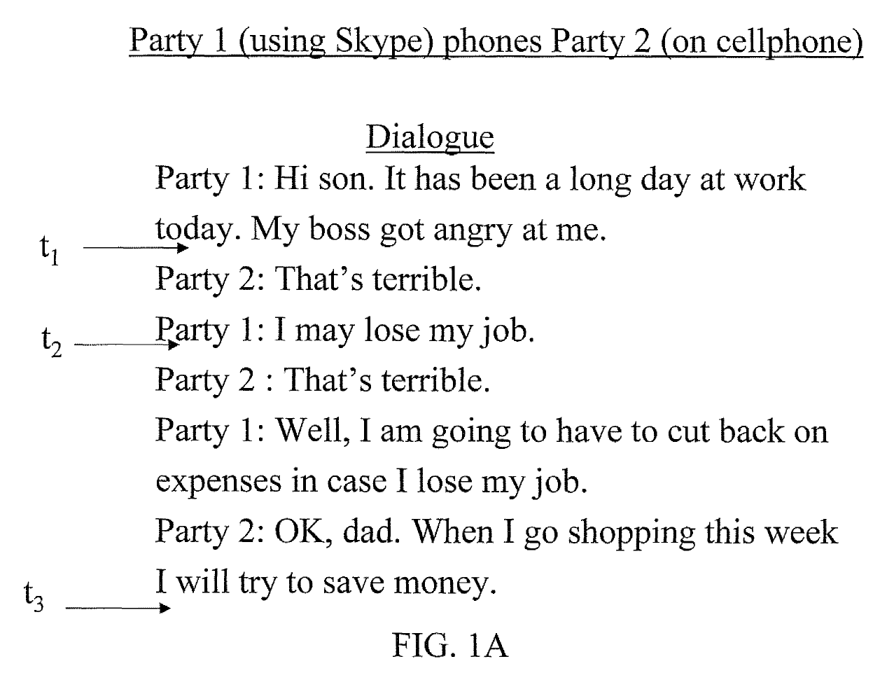

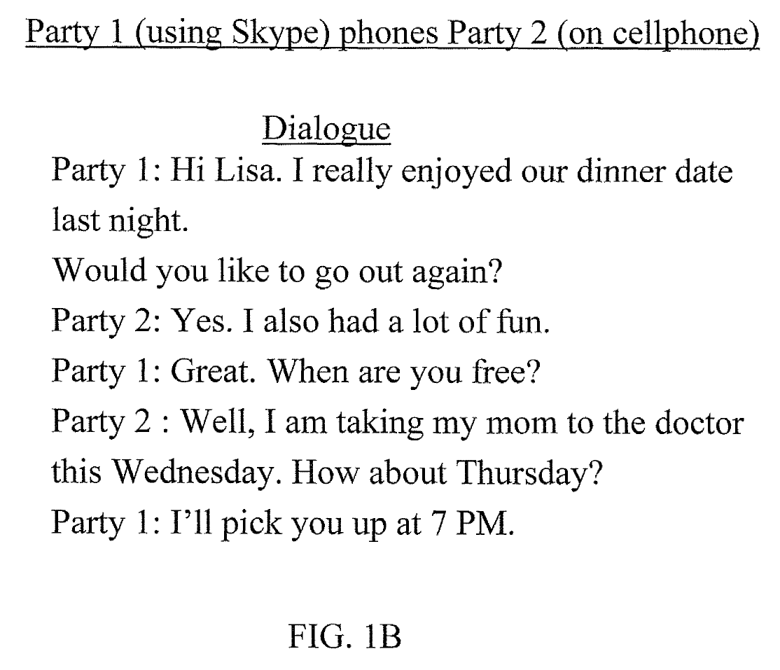

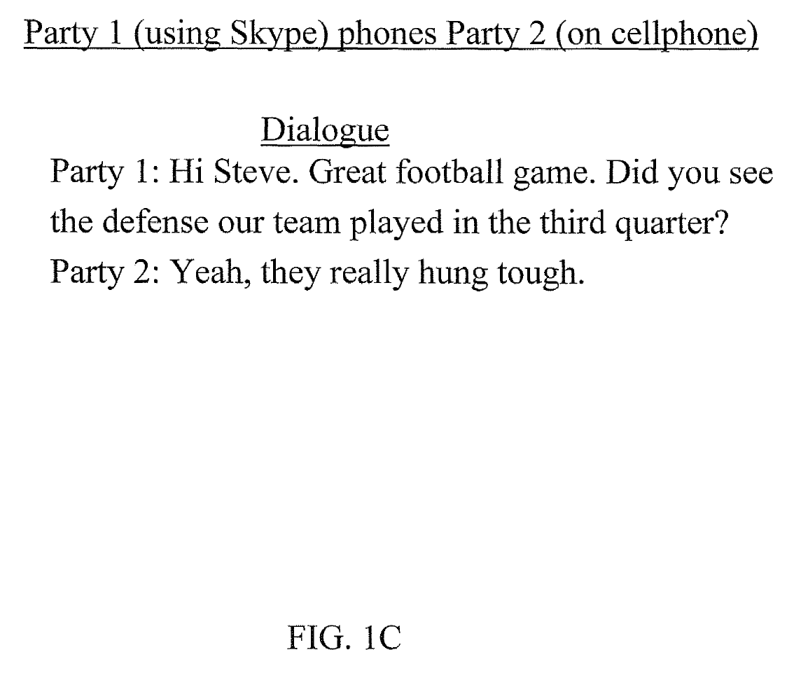

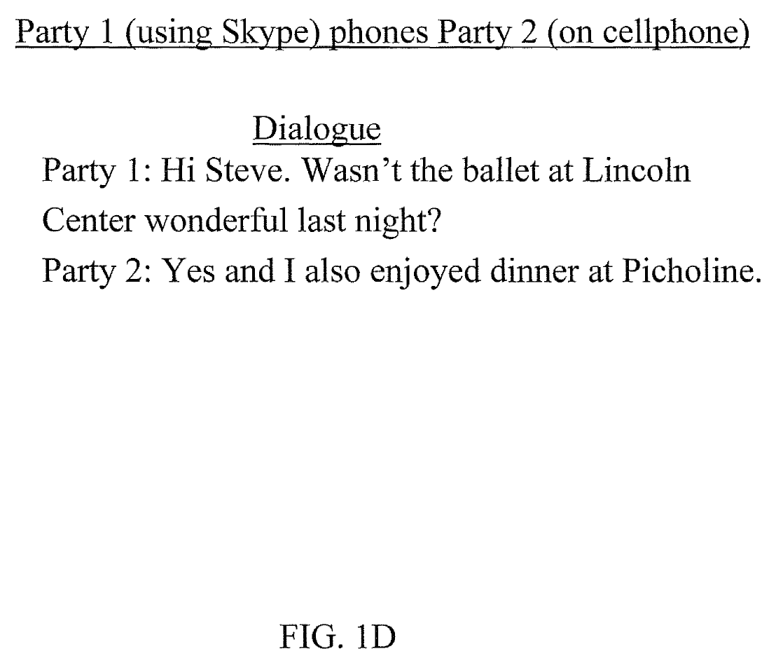

### Use Scenario 1 (Example of FIG. 1A)

According to this scenario, a first user (i.e. ‘party 1’) of a desktop computer phones a second user (i.e. ‘party 2’) cellular telephone using VOIP software residing on the desktop, such as Skype® software. During their conversation, the content of their conversation is analyzed. In this particular example, a speech recognition engine generates words from the digitized audio signal and the words are analyzed.

The advertisement provisioning system is operative such that certain word combinations (i.e. spoken by one or more of the users during their voice conversation) are detected, and in response to the detected word combinations, advertisements are served to the desktop computer and/or to the cellular telephone. In this example, the advertisements may be presented as text and/or links that are displayed on a display device coupled to the desktop computer and/or the screen of the cellular telephone. One example conversation is presented in FIG. 1A. According to the example of FIG. 1, a father is explaining his stressful situation and work and his job insecurities to his son. The father explains that they will need to cut back on expenses.

Various times in the conversation are referred to as t₁, t₂, and t₃. At time t₁, the system detects that party 1 may be experiencing feelings of stress (for example, from the phase ‘angry at me’ or from some other indicator such as a detected stress in party 1's voice). At that time, a link to a local spa may be sent to party 1's desktop.

At time t₂, the system detects that system that party 2 is exhibiting anxiety over his employment situation, and sends a link to an employment web site or employment agency.

At time t₃, the system detects that party 2 is planning on shopping and wants to save money. At this time, the system send an advertisement for a local discount store, or some sort of coupon, to the cellphone screen of party 2.

### Use Scenario 2 (Example of FIG. 1B)

In this example, party 1 and party 2 are friends of the opposite sex or a dating couple.

According to this example, party 1 and party 2 agree to go on a date Thursday night. In this example, advertisements or discounts for local restaurants may be sent to each display screen.

In one variation, it is possible to detect who the male party is and who the female party is. This may be accomplished by analyzing the voice characteristic and/or from verbal cues. For example, usually “Lisa” is a female name, so if ‘party 1’ says ‘Hi Lisa” it may be inferred that party 2 is a female. According to on example related to this variation, respective advertisements for apparel may be sent to each display screen: the desktop screen of party 1 (i.e. the desktop screen) receives an advertisement for male apparel while the cellphone screen of party 2 receives an advertisement for female apparel.

In one variation, the type of apparel advertised may be determined by the context of the conversation—in this example, advertisements for eveningwear apparel may be provided.

### Use Scenario 3 (Examples of FIGS. 1C and 1D)

In use scenario 3, a vendor, for example, a car vendor, has purchased the right to present an advertisement for a pre-determined product type (i.e. a motor vehicle), and it is desirable to present that advertisement for the most relevant model of the motor vehicle.

According to the example of FIG. 1C, the content of the conversation is analyzed by the system, and an advertisement for a SUV or sports truck is served to one or more of the client terminal devices (i.e. the desktop or the cellphone), for example, because the phrase ‘great football game’ is detected.

According to the example of FIG. 1D, an advertisement for a luxury vehicle is provided, because the phrase ‘dinner at Picholine’ (all expense Manhattan restaurant) is detected.

For convenience, certain terms employed in the specification, examples, and appended claims are collected here.

Some Brief Definitions

As used herein, ‘providing’ of media or media content includes one or more of the following: (i) receiving the media content (for example, at a server cluster comprising at least one cluster, for example, operative to analyze the media content and/or at a proxy); (ii) sending the media content; (iii) generating the media content (for example, carried out at a client device such as a cell phone and/or PC); (iv) intercepting; and (v) handling media content, for example, on the client device, on a proxy or server.

As used herein, a ‘multi-party’ voice conversation includes two or more parties, for example, where each party communicated using a respective client device including but not limited to desktop, laptop, cell-phone, and personal digital assistant (PDA).

In one example, the electronic media content from the multi-party conversation is provided from a single client device (for example, a single cell phone or desktop). In another example, the media from the multi-party conversation includes content from different client devices.

Similarly, in one example, the media electronic media content from the multi-party conversation is from a single speaker or a single user. Alternatively, in another example, the media electronic media content from the multi-party conversation is from multiple speakers.

The electronic media content may be provided as streaming content. For example, streaming audio (and optionally video) content may be intercepted, for example, as transmitted a telecommunications network (for example, a packet switched or circuit switched network). Thus, in some embodiments, the conversation is monitored on an ongoing basis during a certain time period.

Alternatively or additionally, the electronic media content is pre-stored content, for example, stored in any combination of volatile and non-volatile memory.

As used herein, ‘providing at least one advertisement in accordance with a least one feature’ includes one or more of the following:

i) configuring a client device (i.e. a screen of a client device) to display advertisement such that display of the client device displays advertisement in accordance with the feature of media content. This configuring may be accomplished, for example, by displaying a advertising message using an email client and/or a web browser and/or any other client residing on the client device;

ii) sending or directing or targeting an advertisement to a client device in accordance with the feature of the media content (for example, from a client to a server, via an email message, an SMS or any other method);

iii) configuring an advertisement targeting database that indicates how or to whom or when advertisements should be sent, for example, using ‘snail mail to a targeted user—i.e. I this case the database is a mailing list.

Embodiments of the present invention relate to providing or targeting advertisement to an ‘one individual associated with a party of the multi-party voice conversation.’

In one example, this individual is actually a participant in the multi-party voice conversation. Thus, a user may be associated with a client device (for example, a desktop or cellphone) for speaking and participating in the multi-party conversation. According to this example, the user's client device is configured to present (i.e. display and or play audio content) the targeted advertisement.

In another example, the advertisement is ‘targeted’ or provided using SMS or email or any other tecnque. The ‘associated individual’ may thus include one or more of: a) the individual himself/herself; b) a spouse or relative of the individual (for example, as determined using a database); c) any other person for which there is an electronic record associating the other person with the participant in the multi-party conversation (for example, a neighbor as determined from a white pages database, a co-worker as determined from some purchasing ‘discount club’, a member of the same club or church or synagogue, etc).

### Detailed Description of Block Diagrams and Flow Charts

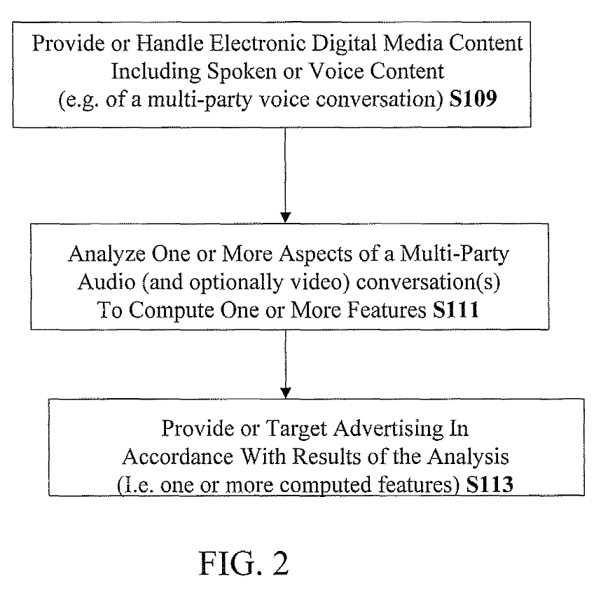

FIG. 2 refers to an exemplary technique for provisioning advertisements.

In step S109, electronic digital media content including spoken or voice content (e.g. of a multi-party audio conversation) is provided—e.g. received and/or intercepted and/or handled.

In step S111, one or more aspects of electronic voice content (for example, content of multi-party audio conversation are analyzed), or context features are computed. In one example, the words of the conversation are extracted from the voice conversation and the words are analyzed, for example, for a presence of key phrases.

In another example, discussed further below, an accent of one or more patties to the conversation is detected. If, for example, one party has a ‘Texas accent’ then this increases a likelihood that the party will receive (for example, on her terminal such as a cellphone or desktop) products preferred by people of Texas origin.

In another example, the multi-party conversation is a ‘video conversation’ (i.e. voice plus video). If a conversation participant is wearing, for example, a hat or jacket associated with a certain sports team (for example, a particular baseball team), that person may be served one or more advertisements for tickets to see that sports team play. The dress of one or more conversation participants is one example of ‘context.’

In step S113, one or more operations are carried out to facilitate provisioning advertising in accordance with results of the analysis of step S111. One example of ‘facilitating the provisioning of advertising’ is using an ad server to serve advertisements to a user. Alternatively or additionally, another example of ‘facilitating the provisioning of advertising’ is using an aggregation service such as Google AdSense®. More examples of provisioning advertisement(s) are described below.

It is noted that the aforementioned ‘use scenarios’ related to FIGS. 1A-1D provide just a few examples of how to carry out the technique of FIG. 2.

It is also noted that the ‘use scenarios’ relate to the case where a multi-party conversation is monitored on an ongoing basis (i.e. S111 includes monitoring the conversation either in real-time or with some sort of time delay). Alternatively or additionally, the multi-party conversation may be saved in some sort of persistent media, and the conversation may be analyzed S111 ‘off line’

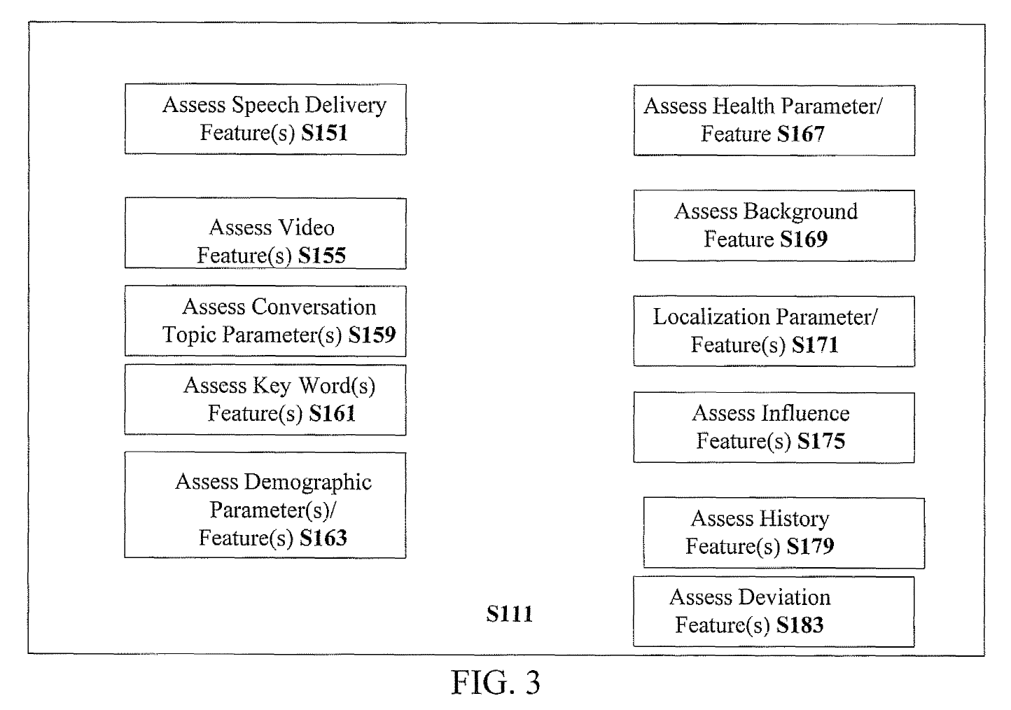

Obtaining a Demographic Profile of a Conversation Participant from Audio and/or Video Data Relating to a Multi-Party Voice and Optionally Video Conversation (with Reference to FIG. 3)

FIG. 3 provides exemplary types of features that are computed or assessed S111 when analyzing the electronic media content. These features include but are not limited to speech delivery features S151, video features S155, conversation topic parameters or features S159, key word(s) feature S161, demographic parameters or features S163, health or physiological parameters of features S167, background features S169, localization parameters or features S175, influence features S175, history features S179, and deviation features S183.

Thus, in some embodiments, by analyzing and/or monitoring a multi-party conversation (i.e. voice and optionally video), it is possible to assess (i.e. determine and/or estimate) S163 if a conversation participant is a member of a certain demographic group from a current conversation and/or historical conversations. This information may then be used to more effectively provide an advertisement to the user and/or an associate of the user.

Relevant demographic groups include but are not limited to: (i) age; (ii) gender; (iii) educational level; (iv) household income; (v) ethnic group and/or national origin; (vi) medical condition.

(i) age/(ii) gender—in some embodiments, the age of a conversation participant is determined in accordance with a number of features, including but not limited to one or more of the following: speech content features and speech delivery features.
A) Speech content features—after converting voice content into text, the text may be analyzed for the presence of certain words or phrases. This may be predicated, for example, on the assumption that teenagers use certain slang or idioms unlikely to be used by older members of the population (and vice-versa).
B) Speech delivery features—in one example, one or more speech delivery features such as the voice pitch or speech rate (for example, measured in words/minute) of a child and/or adolescent may be different than and speech delivery features of an young adult or elderly person.

The skilled artisan is referred to, for example, US 20050286705, incorporated herein by reference in its entirety, which provides examples of certain techniques for extracting certain voice characteristics (e.g. language/dialect/accent, age group, gender).

In one example related to video conversations, the user's physical appearance can also be indicative of a user's age and/or gender. For example, gray hair may indicate an older person, facial hair may indicate a male, etc.

Once an age or gender of a conversation participant is assessed, it is possible to target advertisement(s) to the participant (or an associated thereof) accordingly.

(ii) educational level—in general, more educated people (i.e. college educated people) tend to use a different set of vocabulary words than less educated people.

Advertisement(s) can be targeted using this demographic parameter as well. For example, certain book vendors may choose to selectively serve an ad only to college educated people

(iv) household income—certain audio and/or visual clues may provide an indication of a household income. For example, a video image of a conversation participant may be examined, and a determination may be made, for example, if a person is wearing expensive jewelry, a fur coat or a designer suit.

In another example, a background video image may be examined for the presence of certain products that indicate wealth. For example, images of the room furnishing (i.e. for a video conference where one participant is ‘at home’) may provide some indication.

In another example, the content of the user's speech may be indicative of wealth or income level. For example, if the user speaks of frequenting expensive restaurants (or alternatively fast-food restaurants) this may provide an indication of household income.

(v) ethnic group and/or national origin—this feature also may be assessed or determined using one or more of speech content features and speech delivery features.

(vi) number of children per household—this may be observable from background ‘voices’ or noise or from a background image.

One example of ‘speech content features’ includes slang or idioms that tend to be used by a particular ethnic group or non-native English speakers whose mother tongue is a specific language (or who come from a certain area of the world).

One example of ‘speech delivery features’ relates to a speaker's accent. The skilled artisan is referred, for example, to US 2004/0096050, incorporated herein by reference in its entirety, and to US 2006/0067508, incorporated herein by reference in its entirety.

In some embodiments (and where permitted by law and/or by the user), one or more video features of a speaker's appearance may indicate an ethnic origin or race of the user.

(vi) medical condition—In some embodiments, a user's medical condition (either temporary or chronic) may be assessed in accordance with one or more audio and/or video features.

In one example, it may be visually determined if a user is obese. In one particular example, a supermarket is targeting ads at users, and an obese user would be provided with a coupon for a low-calorie product. This could be a useful to test-market new products.

In another example, breathing sounds may be analyzed, and breathing rate may be determined. This may be indicative of whether or not a person has some sort of respiratory ailment.

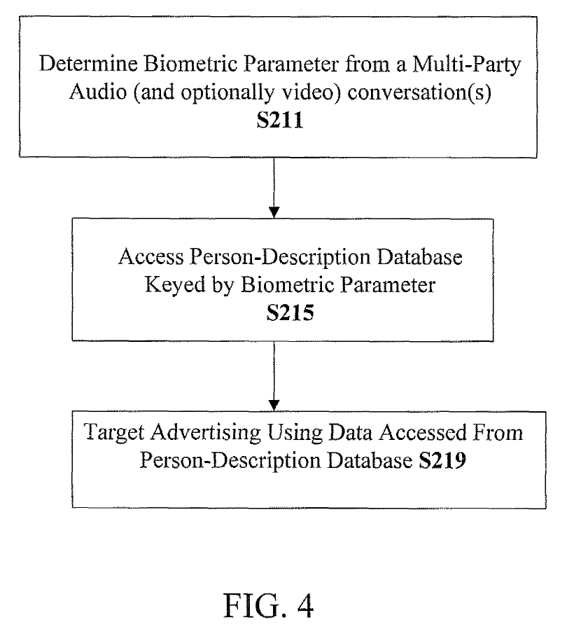

Storing Biometric Data (for Example, Voice-Print Data) and Demographic Data (with Reference to FIG. 4)

Sometimes it may be convenient to store data about previous conversations and to associate this data with user account information. Thus, the system may determine from a first conversation (or set of conversations) specific data about a given user with a certain level of certainty.

Later, when the user engages in a second multi-party conversation, it may be advantageous to access the earlier-stored demographic data in order to provide to the user the most appropriate advertisement. Thus, there is no need for the system to re-profile the given user.

In another example, the earlier demographic profile may be refined in a later conversation by gathering more ‘input data points.’

In some embodiments, the user may be averse to giving ‘account information’—for example, because there is a desire not to inconvenience the user.

Nevertheless, it may be advantageous to maintain a ‘voice print’ database which would allow identifying a given user from his or her ‘voice print.’

Recognizing an identity of a user from a voice print is known in the art—the skilled artisan is referred to, for example, US 2006/0188076; US 2005/0131706; US 2003/0125944; and US 2002/0152078 each of which is incorporated herein by reference in entirety.

Thus, in step S211 content (i.e. voice content and optionally video content) if a multi-party conversation is analyzed and one or more biometric parameters or features (for example, voice print or face ‘print’) are computed. The results of the analysis and optionally demographic data are stored and are associated with a user identity and/or voice print data.

During a second conversation, the identity of the user is determined and/or the user is associated with the previous conversation using voice print data based on analysis of voice and/or video content S215. At this point, the previous demographic information of the user is available.

Optionally, the demographic profile is refined by analyzing the second conversation.

In accordance with demographic data, one or more operations related to provisioning advertisement to the user or an associated thereof is then carried out S219.

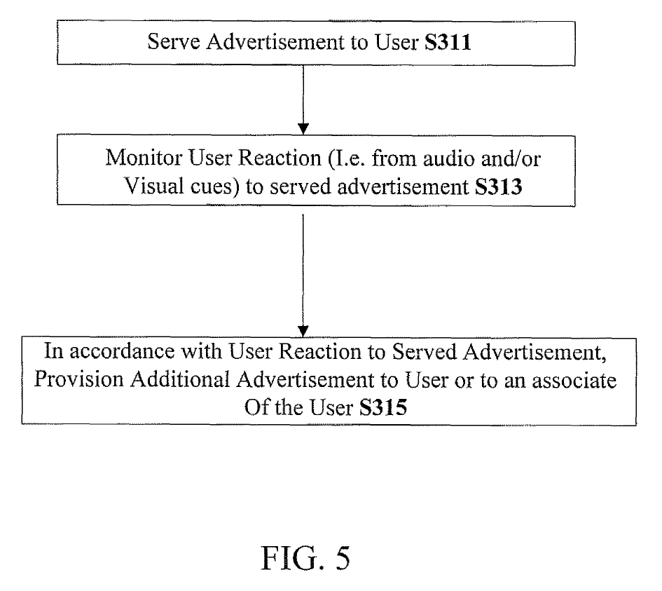

Feedback on Advertisement (with Reference to FIG. 5)

In some embodiments, after an advertisement is initially served S311 to a user, the reactions of one or more conversation participants to the served advertisement may be detected and monitored or analyzed S313. Exemplary user reactions include but are not limited to: (i) audio reactions, (ii) visual reactions, and (iii) user-GUI reactions

(i) Audio reactions to advertisements: When the participants in the conversation are discussing the content of one of the advertisements served during the conversation, this information may be noted as feedback. When one of the participants is acknowledging the content of one of the advertisements, for example by reading out the ad during the conversation, this information may be noted.

(ii) Visual reactions to advertisements: When one of the participants observes the content of the advertisement, for example by tracking the movement of his eyes towards the region of the display showing the advertisements

(iii) GUI reactions to advertisements: When one of the participants observes the content of the advertisement, the conversation participant may engage a user interface of a client device (e.g. a desktop device running a VOIP application, a cellular telephone, PDA, etc) to carry out an action related to the advertisement, for example, clicking a link, contacting the advertiser, visiting the advertiser's websites. It is possible to track the user engagement of the user interface (e.g. after an advertisement is served S311) tracking the movements of the mouse or other pointing device over the ad display area, or for example by tracking a click-through on the ads, this information may be noted as feedback.

The data about user reactions may be used in any of a number of ways. In one example, the data may be used for assessing the impact of the ads on the participants of the conversation. This may be useful for determining, for example, an appropriate cost to the advertiser.

In another example, as shown in FIG. 5, further provisioning S315 of advertisement may be influenced by user reactions. For example, if an advertisement is sent to only one conversation participant, and this conversation participant reacts positively, the same advertisement (or a related advertisement) may be sent to other conversation participants. Alternatively, if the user reacts positively, an additional related advertisement may be served to the user.

If the user reacts negatively, a user profile may be updated for the negatively-reacting user indicating that the user has an aversion and/or a lack of responsiveness to the advertisement. Alternatively, the user may be offered a larger discount to ‘entice’ him or her to engage the advertisement.

Discussion of Exemplary Apparatus

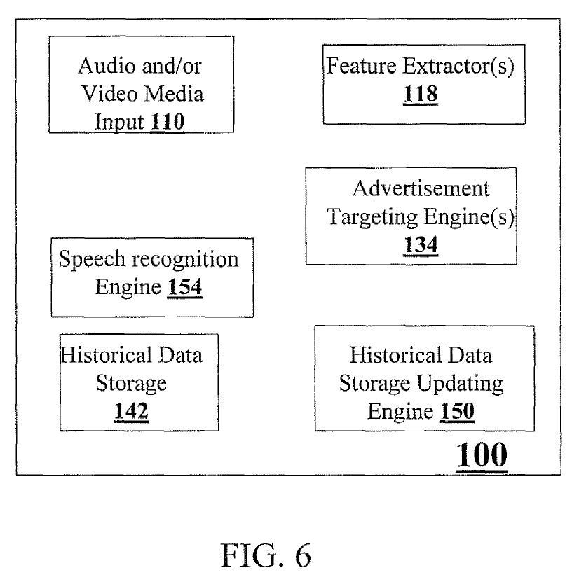

FIG. 6 provides a block diagram of an exemplary system 100 for facilitating the provisioning of advertisements in according with some embodiments of the present invention. The apparatus or system, or any component thereof may reside on any location within a computer network (or single computer device)—i.e. on the client terminal device 10, on a server or cluster of servers (not shown), proxy, gateway, etc. Any component may be implemented using any combination of hardware (for example, non-volatile memory, volatile memory, CPUs, computer devices, etc) and/or software—for example, coded in any language including but not limited to machine language, assembler, C, C++, Java, C#, Perl etc.

The exemplary system 100 may an input 110 for receiving one or more digitized audio and/or visual waveforms, a speech recognition engine 154 (for converting a live or recorded speech signal to a sequence of words), one or more feature extractor(s) 118, one or more advertisement targeting engine(s) 134, a historical data storage 142, and a historical data storage updating engine 150.

Exemplary implementations of each of the aforementioned components are described below.

It is appreciated that not every component in FIG. 6 (or any other component described in any figure or in the text of the present disclosure) must be present in every embodiment. Any element in FIG. 6, and any element described in the present disclosure may be implemented as any combination of software and/or hardware. Furthermore, any element in FIG. 6 and any element described in the present disclosure may be either reside on or within a single computer device, or be a distributed over a plurality of devices in a local or wide-area network.

Audio and/or Video Input 110

In some embodiments, the media input 110 for receiving a digitized waveform is a streaming input. This may be useful for ‘eavesdropping’ on a multi-party conversation in substantially real time. In some embodiments, ‘substantially real time’ refers to refer time with no more than a pre-determined time delay, for example, a delay of at most 15 seconds, or at most 1 minute, or at most 5 minutes, or at most 30 minutes, or at most 60 minutes.

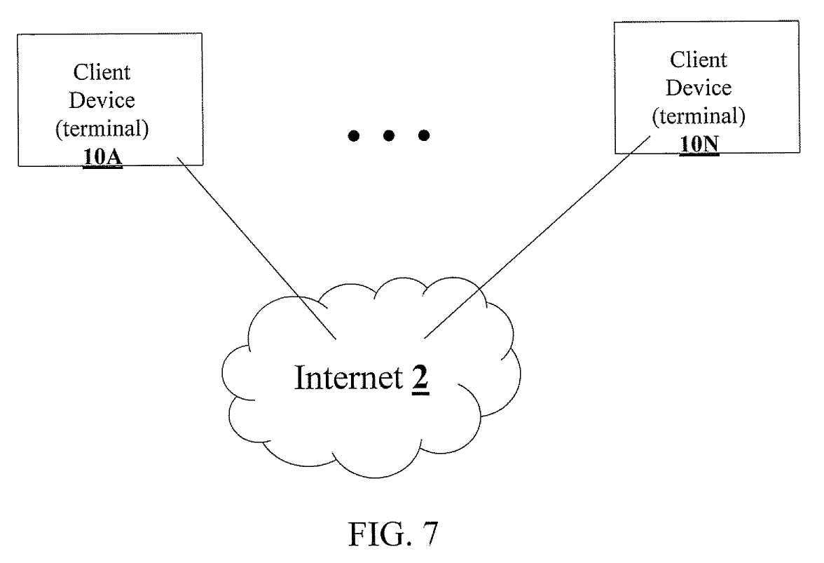

FIG. 7, a multi-party conversation is conducted using client devices or communication terminals 10 (i.e. N terminals, where N is greater than or equal to two) via the Internet 2. In one example, VOIP software such as Skype® software resides on each terminal 10.

In one example, ‘streaming media input’ 110 may reside as a ‘distributed component’ where an input for each party of the multi-party conversation resides on a respective client device 10. Alternatively or additionally, streaming media signal input 110 may reside at least in part ‘in the cloud’ (for example, at one or more servers deployed over wide-area and/or publicly accessible network such as the Internet 20). Thus, according to this implementation, and audio streaming signals and/or video streaming signals of the conversation (and optionally video signals) may be intercepted as they are transmitted over the Internet.

In yet another example, input 110 does not necessarily receive or handle a streaming signal. In one example, stored digital audio and/or video waveforms may be provided stored in non-volatile memory (including but not limited to flash, magnetic and optical media) or in volatile memory.

It is also noted, with reference to FIG. 7, that the multi-party conversation is not required to be a VOIP conversation. In yet another example, two or more parties are speaking to each other in the same room, and this conversation is recorded (for example, using a single microphone, or more than one microphone). In this example, the system 100 may include a ‘voice-print’ identifier (not shown) for determining an identity of a speaking party (or for distinguishing between speech of more than one person).

In yet another example, at least one communication device is a cellular telephone communicating over a cellular network.

In yet another example, two or more parties may converse over a ‘traditional’ circuit-switched phone network, and the audio sounds may be streamed to advertisement system 100 and/or provided as recording digital media stored in volatile and/or non-volatile memory.

Feature Extractor(s) 118

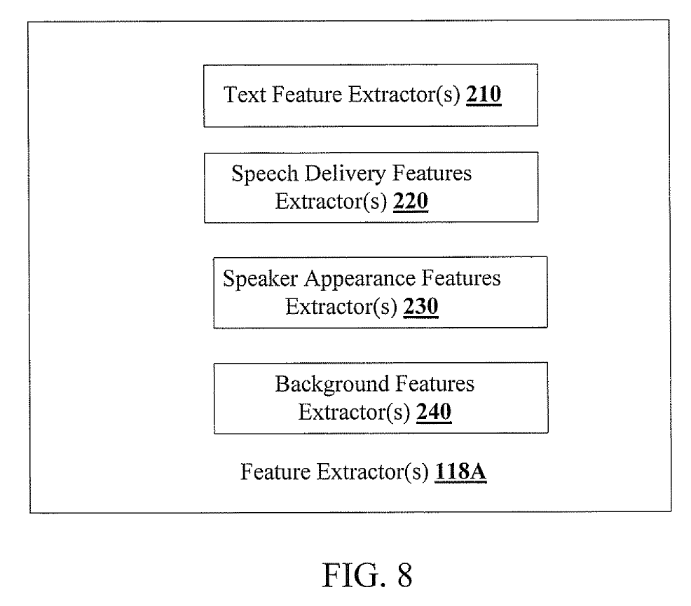

FIG. 8 provides a block diagram of several exemplary feature extractor(s)—this is not intended as comprehensive but just to describe a few feature extractor(s). These include: text feature extractor(s) 210 for computing one or more features of the words extracted by speech recognition engine 154 (i.e. features of the words spoken); speech delivery features extractor(s) 220 for determining features of how words are spoken; speaker visual appearance feature extractor(s) 230 (i.e. provided in some embodiments where video as well as audio signals are analyzed); and background features (i.e. relating to background sounds or noises and/or background images).

It is noted that the feature extractors may employ any technique for feature extraction of media content known in the art, including but not limited to heuristically techniques and/or ‘statistical AI’ and/or ‘data mining techniques’ and/or ‘machine learning techniques’ where a training set is first provided to a classifier or feature calculation engine. The training may be supervised or unsupervised.

Exemplary techniques include but are not limited to tree techniques (for example binary trees), regression techniques. Hidden Markov Models, Neural Networks, and meta-techniques such as boosting or bagging. In specific embodiments, this statistical model is created in accordance with previously collected “training” data. In some embodiments, a scoring system is created. In some embodiments, a voting model for combining more than one technique is used.

Appropriate statistical techniques are well known in the art, and are described in a large number of well known sources including, for example, Data Mining: Practical Machine Learning Tools and Techniques with Java Implementations by Ian H. Witten, Eibe Frank; Morgan Kaufmann, October 1999), the entirety of which is herein incorporated by reference.

It is noted that in exemplary embodiments a first feature may be determined in accordance with a different feature, thus facilitating ‘feature combining.’

In some embodiments, one or more feature extractors or calculation engine may be operative to effect one or more ‘classification operations’—e.g. determining a gender of a speaker, age range, ethnicity, income, and many other possible classification operations.

Each element described in FIG. 8 is described in further detail below.

Text Feature Extractor(s) 210

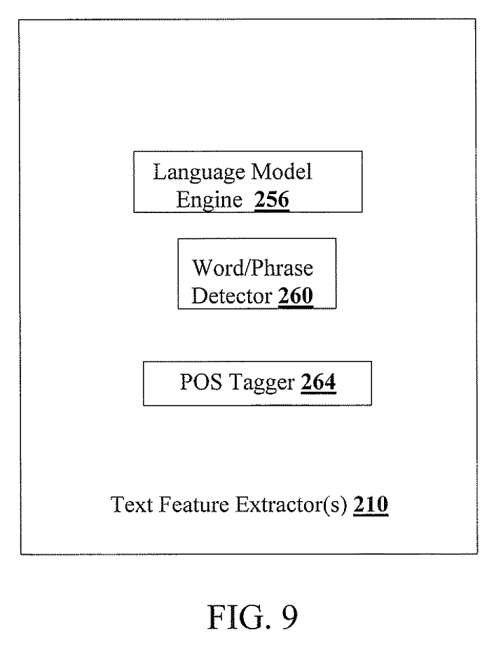

FIG. 9 provides a block diagram of exemplary text feature extractors. Thus, certain phrases or expressions spoken by a participant in a conversation may be identified by a phrase detector 260.

In one example, when a speaker uses a certain phrase, this may indicate a current desire or preference. For example, if a speaker says “I am quite hungry” this may indicate that a food product add should be sent to the speaker.

In another example, a speaker may use certain idioms that indicate general desire or preference rather than a desire at a specific moment. For example, a speaker may make a general statement regarding a preference for American cars, or a professing love for his children, or a distaste for a certain sport or activity. These phrases may be detected and stored as part of a speaker profile, for example, in historical data storage 142.

The speaker profile built from detecting these phrases, and optionally performing statistical analysis, may be useful for present or future provisioning of ads to the speaker or to another person associated with the speaker.

The phrase detector 260 may include, for example, a database of pre-determined words or phrases or regular expressions.

In one example, it is recognized that the computational cost associated with analyzing text to determine the appearance of certain regular phrases (i.e. from a pre-determined set) may increase with the size of the set of phrases.

Thus, the exact set of phrases may be determined by various business considerations. In one example, certain sponsors may ‘purchase’ the right to include certain phrases relevant for the sponsor's product in the set of words or regular expressions.

In another example, the text feature extractor(s) 210 may be used to provide a demographic profile of a given speaker. For example, usage of certain phrases may be indicative of an ethnic group of a national origin of a given speaker. As will be described below, this may be determined using some sort of statistical model, or some sort of heuristics, or some sort of scoring system.

In some embodiments, it may be useful to analyze frequencies of words (or word combinations) in a given segment of conversation using a language model engine 256.

For example, it is recognized that more educated people tend to use a different set of vocabulary in their speech than less educated people. Thus, it is possible to prepare pre-determined conversation ‘training sets’ of more educated people and conversation ‘training sets’ of less educated people. For each training set, frequencies of various words may be computed. For each predetermined conversation ‘training set,’ a language model of word (or word combination) frequencies may be constructed.

According to this example, when a segment of conversation is analyzed, it is possible (i.e. for a given speaker or speakers) to compare the frequencies of word usage in the analyzed segment of conversation, and to determine if the frequency table more closely matches the training set of more educated people or less educated people, in order to obtain demographic data (i.e.

This principle could be applied using pre-determined ‘training sets’ for native English speakers vs. non-native English speakers, training sets for different ethnic groups, and training sets for people from different regions. This principle may also be used for different conversation ‘types.’ For example, conversations related to computer technologies would tend to provide an elevated frequency for one set of words, romantic conversations would tend to provide an elevated frequency for another set of words, etc. Thus, for different conversation types, or conversation topics, various training sets can be prepared. For a given segment of analyzed conversation, word frequencies (or word combination frequencies) can then be compared with the frequencies of one or more training sets.

The same principle described for word frequencies can also be applied to sentence structures—i.e. certain pre-determined demographic groups or conversation type may be associated with certain sentence structures. Thus, in some embodiments, a part of speech (POS) tagger 264 is provided.

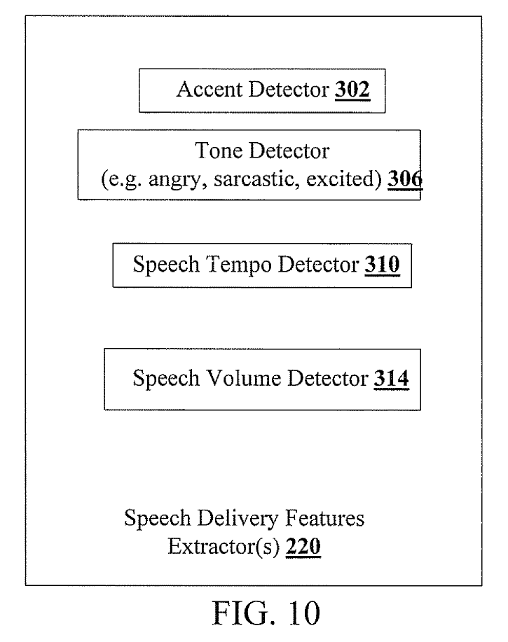

A Discussion of FIGS. 10-15

FIG. 10 provides a block diagram of an exemplary system 220 for detecting one or more speech delivery features. This includes an accent detector 302, tone detector 306, speech tempo detector 310, and speech volume detector 314 (i.e. for detecting loudness or softness.

As with any feature detector or computation engine disclosed herein, speech delivery feature extractor 220 or any component thereof may be pre-trained with ‘training data’ from a training set.

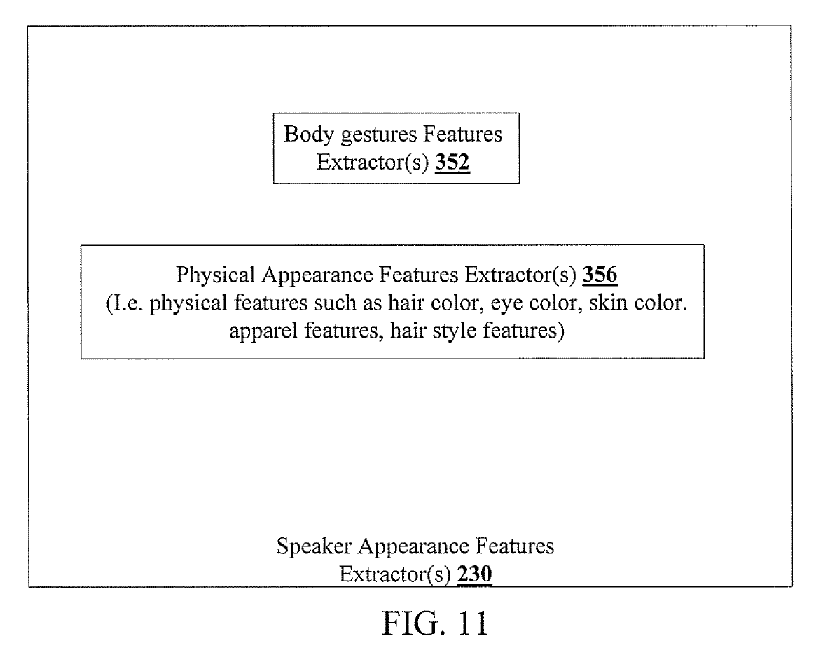

FIG. 11 provides a block diagram of an exemplary system 230 for detecting speaker appearance features—i.e. for video media content for the case where the multi-party conversation includes both voice and video. This includes a body gestures feature extractor(s) 352, and physical appearance features extractor 356.

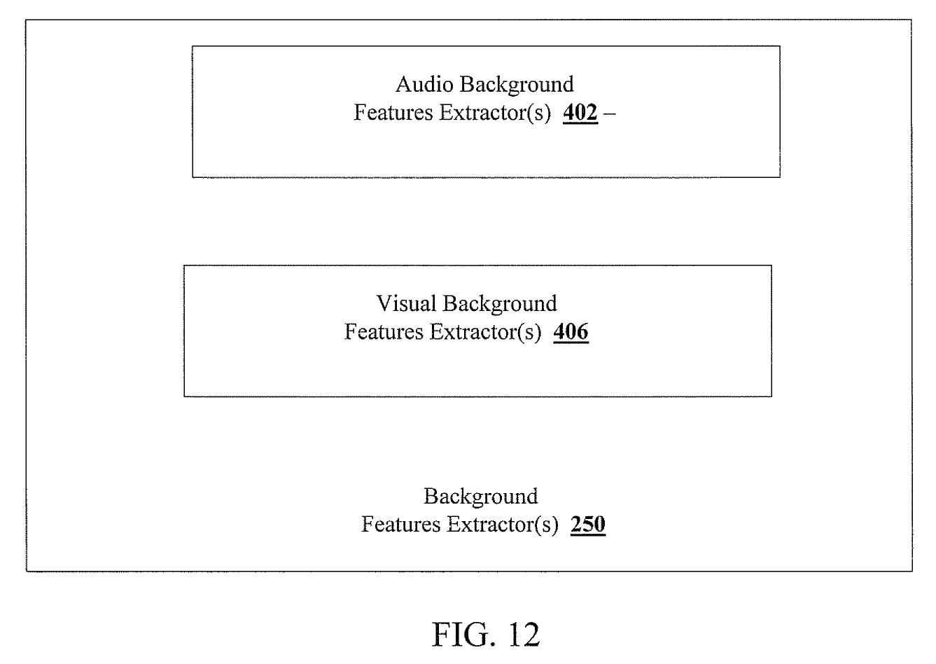

FIG. 12 provides a block diagram of an exemplary background feature extractor(s) 250. This includes (i) audio background features extractor 402 for extracting various features of background sounds or noise including but not limited to specific sounds or noises such as pet sounds, an indication of background talking, an ambient noise level, a stability of an ambient noise level, etc; and (ii) visual background features extractor 406 which may, for example, identify certain items or features in the room, for example, certain products are brands present in a room.

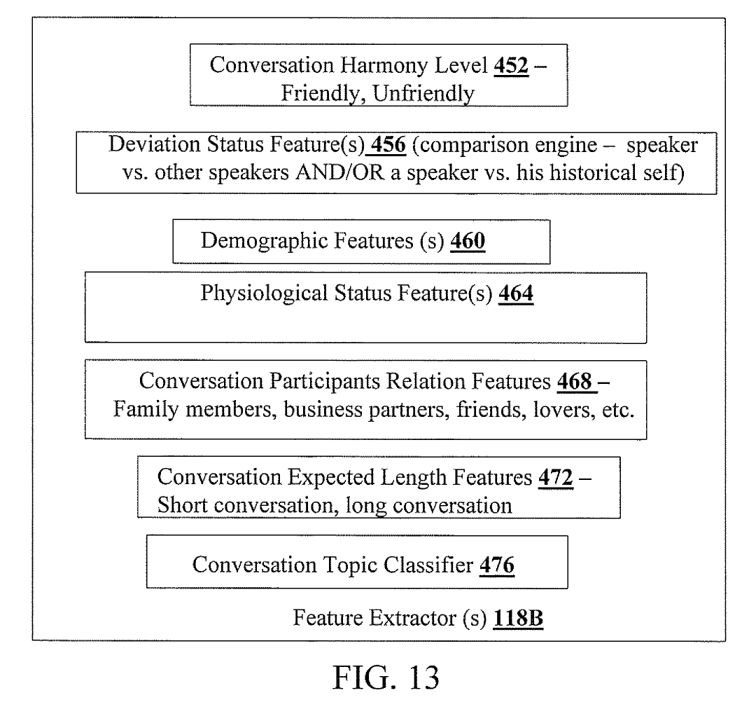

FIG. 13 provides a block diagram of an additional feature extractors 118 for determining one or more features of the electronic media content of the conversations. Certain features may be ‘combined features’ or ‘derived features’ derived from one or more other features.

This includes a conversation harmony level classifier (for example, determining if a conversation is friendly or unfriendly and to what extent) 452, a deviation feature calculation engine 456, a feature engine for demographic feature(s) 460, a feature engine for physiological status 464, a feature engine for conversation participants relation status 468 (for example, family members, business partners, friends, lovers, spouses, etc), conversation expected length classifier 472 (i.e. if the end of the conversation is expected within a ‘short’ period of time, the advertisement providing may be carried out differently than for the situation where the end of the conversation is not expected within a short period of time), conversation topic classifier 476, etc.

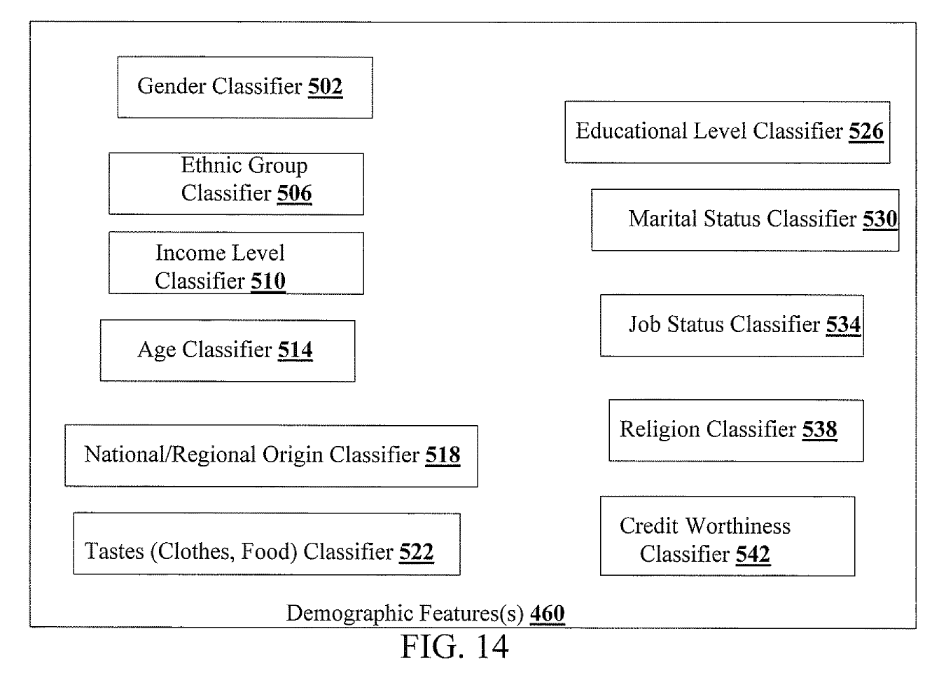

FIG. 14 provides a block diagram of exemplary demographic feature calculators or classifiers. This includes gender classifier 502, ethic group classifier 506, income level classifier 510, age classifier 514, national/regional origin classifier 518, tastes (for example, clothes and good) classifier 522, educational level classifier 5267, marital status classifier 530, job status classifier 534 (i.e. employed vs. unemployed, manager vs. employee, etc), religion classifier 538 (i.e. Jewish, Christian, Hindu, Muslim, etc), and credit worthiness classifier 542 (for example, has a person mentioned something indicative of being a ‘good credit risk’

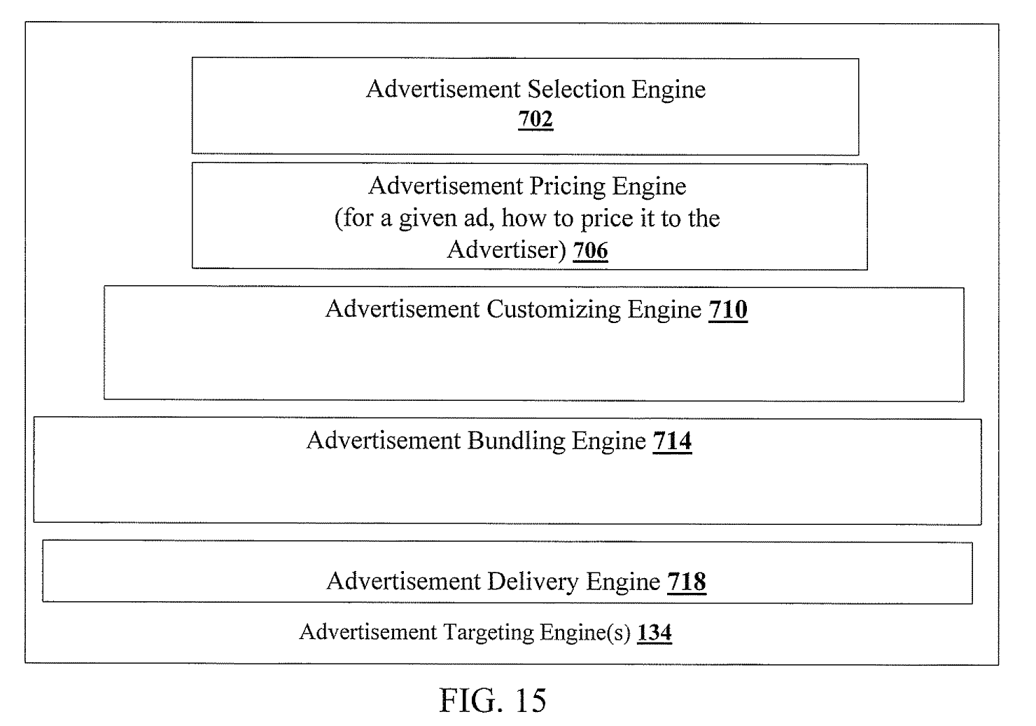

FIG. 15 provides a block diagram of exemplary advertisement targeting engine operative to target advertisement in accordance with one or more computed features of the electronic media content. According to the example of FIG. 16, the advertisement targeting engine(s) 134 includes: advertisement selection engine 702 (for example, for deciding which ad to select to target and/or serve—for example, a sporting goods product ad may be selected for a ‘sports fan’ while a coupon for the opera may be selected for an ‘upper income Manhattan urbanite’); advertisement pricing engine 706 (for example, for determining a price to charge for a served ad to the vendor or mediator who purchased the right to have the ad targeted to a user), advertisement customization engine 710 (for example, for a given book ad will the paperback or hardback ad be sent, etc), advertisement bundling engine 714 (for example, for determining whether or not to bundle serving of ads to several users simultaneously, to bundle provisioning of various advertisements to serve, for example a ‘cola’ ad right after a ‘popcorn’ ad), an advertisement delivery engine 718 (for example for determining the best way to delivery the ad—for example, a teenager many receive an ad via SMS and for a senior citizen a mailing list may be modified).

In another example, advertisement delivery engine 718 may decide a parameter for a delayed provisioning of advertisement—for example, 10 minutes after the conversation, several hours, a day, a week, etc.

In another example, the ad may be served in the context of a computer gaming environment. For example, games may speak when engaged in a multi-player computer game, and advertisements may be served in a manner that is integrated in the game environment. In one example, for a computer basketball game, the court or ball may be provisioned with certain ads determined in accordance with the content of the voice and/or video content of the conversation between games.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of facilitating advertising, the method comprising:
a) providing electronic media content of a multi-party voice conversation including spoken content of said conversation; and
b) in accordance with at least one feature of said electronic media content, providing at least one advertisement to at least one individual associated with a party of said multi-party voice conversation.

2) The method of claim 1 further comprising:
c) analyzing said electronic media content to compute said at least one feature of said electronic media content.

3) The method of claim 1 wherein said at least one feature includes at least one key words feature indicative of a presence or absence of at least one of:
i) a key word; and
ii) a phrase;
within said electronic media content.

4) The method of claim 1 wherein said at least one feature includes at least one speech delivery feature selected from the group consisting of:
i) an accent feature;
ii) a speech tempo feature;
iii) a voice inflection feature;
iv) a voice pitch feature;
v) a voice loudness feature;
vi) an emotional outburst feature;
wherein said targeting is carried out in accordance with at least one said determined voice characteristic.

5) The method of claim 1 wherein said at least one feature includes at least one video content feature.

6) The method of claim 5 wherein said video content feature is selected from the group consisting of:
i) a visible physical characteristic of a person in an image;
ii) a video background feature; and
iii) a detected physical movement feature;

7) The method of claim 1 wherein said at least one feature includes at least one topic category feature.

8) The method of claim 7 wherein at least one said topic category feature is a topic change feature.

9) The method of claim 8 wherein at least one said topic change feature is selected from the group consisting of:
i) a topic change frequency,
ii) an impending topic change likelihood,
iii) an estimated time until a next topic change; and
iv) a time since a previous topic change

10) The method of claim 1 wherein said at least one feature includes at least one demographic feature selected from the group consisting of:
i) a feature;
ii) an educational level feature;
iii) a household income feature;
iv) a weight feature;
v) an age feature; and
vi) an ethnicity feature.

11) The method of claim 10 wherein at least one said demographic feature is determined in accordance with at least one:
i) an idiom feature;
ii) an accent feature;
iii) a grammar compliance feature;
iv) a voice characteristic feature;
v) a sentence length feature; and
vi) a vocabulary richness feature.

12) The method of claim 1 wherein said at least one feature includes at least physiological parameter feature.

13) The method of claim 12 wherein said physiological parameter is selected from the group consisting of a breathing parameter, a sweat parameter, a coughing parameter, a voice-hoarseness parameter, and a body-twitching parameter.

14) The method of claim 1 wherein said at least one feature includes at least one background feature selected from the group consisting of:
i) a background sound feature; and
ii) a background image.

15) The method of claim 14 wherein said background item is selected from the group consisting of a furniture item and a wall-mounted item.

16) The method of claim 1 wherein said at least one feature includes at least one localization feature selected from the group consisting of:
i) a time localization feature; and
ii) a space localization feature.

17) The method of claim 1 wherein said at least one feature includes at least one historical content feature.

18) The method of claim 1 wherein said at least one feature includes at least one user deviation feature.

19) The method of claim 18 wherein said at least one user deviation feature includes an inter-subject deviation feature.

20) The method of claim 18 wherein said at least one user deviation feature includes a voice property deviation feature.

21) The method of claim 20 wherein said at least one feature includes at least one speech delivery deviation feature selected from the group consisting of:
i) an accent deviation feature;
ii) a voice tone deviation feature;
iii) a voice loudness deviation feature;
iv) a speech rate deviation feature.

22) The method of claim 18 wherein said at least one user deviation feature includes a physiological deviation feature.

23) The method of claim 18 wherein said physiological deviation feature is selected from the group consisting of:
i) a breathing rate deviation feature;
ii) a weight deviation feature.

24) The method of claim 18 wherein said at least one user deviation feature includes vocabulary deviation feature.

25) The method of claim 18 wherein said deviation feature is a user behavior deviation feature.

26) The method of claim 18 wherein said at least one user deviation feature includes a vocabulary deviation feature.

27) The method of claim 26 wherein said vocabulary deviation feature is a profanity deviation feature.

28) The method of claim 18 wherein said at least one user deviation feature includes a history deviation feature.

29) The method of claim 28 wherein said historical deviation feature is selected from the group consisting of:
i) an intra-conversation historical deviation feature; and
ii) an inter-conversation historical deviation feature.

30) The method of claim 18 wherein said at least one user deviation feature includes a person-versus-physical-location deviation feature.

31) The method of claim 18 wherein said at least one user deviation feature includes a person-group deviation feature.

32) The method of claim 18 wherein said at least one feature includes person-recognition feature indicative of an identity of a specific person.

33) The method of claim 32 wherein said at least one person-recognition feature includes at least one biometric feature.

34) The method of claim 33 wherein at least one said biometric feature is selected from the group consisting of:
i) a voice-print feature;
ii) a face biometric feature.

35) The method of claim 32 wherein said at least one person-recognition feature includes a clothing-article feature.

36) The method of claim 1 wherein said at least one feature includes a handedness feature.

37) The method of claim 1 wherein said at least one feature includes at least one influence feature.

38) The method of claim 37 wherein said at least one said influence feature includes at least one of:
i) a person influence feature; and
ii) a statement influence feature; and

39) The method of claim 1 wherein said advertisement-providing includes targeting advertisement to a first party of said conversation in accordance with properties of at least one of:
i) speech of a second party of said conversation; and
ii) video of a second party of said conversation,
said second party being different from said first party.

40) The method of claim 1 wherein said advertisement-providing includes selecting an advertisement from a pre-determined pool of advertisements in accordance with at least one said feature.

41) The method of claim 1 wherein said advertisement-providing includes customizing a pre-determined advertisement in accordance with at least one said feature.

42) The method of claim 1 wherein said advertisement-providing includes modifying an advertisement mailing list in accordance with at least one said feature.

43) The method of claim 1 wherein said advertisement-providing includes configuring a client device to present at least one said advertisement in accordance with at least one said feature.

44) The method of claim 1 wherein said advertisement-providing includes determining an ad residence time in accordance with at least one said feature.

45) The method of claim 1 wherein said advertisement-providing includes determining an ad switching rate in accordance with at least one said feature.

46) The method of claim 1 wherein said advertisement-providing includes determining an ad size parameter rate in accordance with at least one said feature.

47) The method of claim 1 wherein said advertisement-providing includes presenting at least one acquisition condition parameter whose value is determined in accordance with at least one said feature.

48) The method of claim 1 wherein said at least one acquisition condition parameter is selected from the group consisting of:
i) a price parameter and
ii) an offered-item time-interval parameter.

49) The method of claim 1 further comprising:
c) providing an additional at least one advertisement in accordance with a feedback feature of detected feedback to said first at least one advertisement.

50) The method of claim 1 wherein said feedback feature is selected from the group consisting of
i) an audio feedback feature;
ii) a video feedback feature;
iii) a feature of user-input client device commands.

51) A method of facilitating advertising, the method comprising:
a) receiving electronic media content of a multi-party voice conversation from at least one client device; and
b) configuring at least one said client device to present advertisement in accordance with at least one feature of said electronic media content.

52) A method of facilitating advertising comprising:
a) effecting at least one voice-content operation selected from the group consisting of:
i) recording an audio voice signal to generate digital audio media content;
ii) effecting a digital audio media content playback operation;
b) computing a feature of said digital audio media content; and
c) providing at least one advertisement in accordance with at least one computed said feature.

53) An apparatus useful for facilitating advertising, the apparatus comprising:
a) a data storage operative to store electronic media content of a multi-party voice conversation including spoken content of said conversation; and
b) a data presentation interface operative to present at least one advertisement in accordance with at least feature of said electronic media content.

54) The apparatus of claim 53 further comprising:
c) a media input operative to receive at least one of audio and video input from at least one party of said multi-party voice conversation and to generate at least some said electronic media content.

55) The apparatus of claim 53 further comprising:
c) a feature calculation engine operative to calculate said at least one feature of said electronic media content.

56) An apparatus useful for facilitating advertising, the apparatus comprising:
a) a data storage operative to store electronic media content of a multi-party voice conversation including spoken content of said conversation; and
b) an advertisement serving engine operative to serve at least one advertisement in accordance with at least feature of said electronic media content.

57) The apparatus of claim 56 further comprising:
c) a feature calculation engine operative to calculate said at least one feature of said electronic media content.

58) The apparatus of claim 56 wherein said feature calculation engine resides at least in part on at least one client terminal device of said multi-party voice conversation

59) A method of facilitating advertising, the method comprising:
a) providing a telecommunications service where a plurality of users send electronic media content via a telecommunications channel; and
b) providing an advertisement service where advertisement content is distributed to at least one target associated with at least one said user in accordance with said electronic media content transmitted via said telecommunications service.

60) The method of claim 59 wherein said communications service is a web-based telecommunications service.

61) The method of claim 59 wherein said communications service is provided at least in part over a circuit-switched network.

62) A method of facilitating advertising, the method comprising:
a) providing a telecommunications service where a plurality of users send electronic media content via a telecommunications channel;
b) receiving advertisement input content for distribution; and
c) effecting at least one advertisement handling operation in accordance with at least feature of transmitted electronic media content of said telecommunications service, said at least one advertisement handling operation being selected from the group consisting of:
i) distributing advertisement content derived from said received advertisement input content;
ii) billing for distribution of said advertisement input content in accordance with said electronic media sent via said telecommunications service.
